(19) United States
(12) Patent Application Publication
(10) Pub. No.: US 2023/0362230 A1
(43) Pub. Date: Nov. 9, 2023

(54) A REMOTE CONTROL BASED INTERACTION METHOD

(71) Applicant: SISTALK TECHNOLOGY (BEIJING) CO., LTD, Beijing (CN)

(72) Inventor: Bo LIU, Beijing (CN)

(21) Appl. No.: 18/044,267

(22) PCT Filed: Oct. 25, 2021
(86) PCT No.: PCT/CN2021/126152

§ 371 Date: Mar. 7, 2023

(30) Foreign Application Priority Data
Oct. 29, 2020 (CN) 202011178262.9

(51) Int. Cl. H04L 67/141; H04L 12/46; H04L 67/025

(52) U.S. Cl. CPC H04L 67/025; H04L 12/46; H04L 67/141

(57) ABSTRACT

A remote control based interaction method comprises following steps: S1. establishing remote connection between the with the first client and the second client, wherein at least one of the first client and the second client is connected to a controllable electronic device; S2. issuing control instruction to the electronic device by means of the first client and/or the second client; S3. obtaining and operating the control instructions based on the connected client by the electronic device. The solution realizes the control of the electronic device connected to at least one of the clients through two remotely connected clients, enabling real-time interaction online regardless of the large distances between two clients, and guaranteeing the instantaneity of the interaction.

This application claims priority to Chinese patent application ‘A remote control based interactive method’ with application No. 202011178262.9 and filed with the Chinese Patent Office on Oct. 29, 2020, and the entire contents of which are incorporated herein as the reference.

### 1. TECHNICAL FIELD

The invention relates to an interactive method, in particular to a remote control based interaction method.

### 2. BACKGROUND ART

With the popularity of smart mobile terminals and the Internet, smart mobile terminals have become a part of people’s daily life instead of a mere communication tool. In particular, with the increasing number of applications on smart mobile terminals, people can easily and flexibly access the interested contents on smart mobile terminals. With the development of society, people gradually have increasingly high requirements for other interactive methods through intelligent mobile terminals, and it is now increasingly difficult to achieve the corresponding needs by simply interacting with images between intelligent mobile terminals.

### 3. SUMMARY OF THE INVENTION

The purpose of the invention is to provide a remote control based interaction method.

To achieve the above purpose, the invention provides remote control based interaction method, comprising:
S1. The first client establishes remote connection with a second client, wherein at least one of the first client and the second client is connected to a controllable electronic device;
S2. The invention issues control instructions to the electronic device by means of the first client and/or the second client;
S3. The electronic device obtains and operates the control instructions based on the connected client.

According to an aspect of the technology, the invention further comprises:

S4. The electronic device starts to operate and provides operational data and data collected through sensors on the electronic device as feedback to the connected client for sharing via remote connection.

According to an aspect of the technology, in S1, in the process of establishing a remote connection between the first client and the second client, the first client and the second client simultaneously establish an instant messaging window for instant message interaction.

According to an aspect of the technology, in S4, after starting the operation of the electronic device, the client connected to the electronic device optionally activates the available sound capture device and/or video capture device to collect the surrounding environment information for sharing via remote connection.

According to an aspect of the technology, in S2, in the process of issuing control instructions to the electronic device via the first client and/or the second client, a timeline is established simultaneously in the display interface of the first client and the second client, to record and display the control instructions according to the timeline.

According to an aspect of the technology, the temporal sequence of the control instructions can be adjusted according to the timeline through the first client or the second client, to update the displays simultaneously at the first client and the second client.

According to an aspect of the technology, in S1, the process of establishing a remote connection between the first client and the second client comprises:
S11. The first client and the second client send a request to establish a remote connection to the remote server, respectively
S12. The remote server responds to the remote connection request and sends a verification request for establishing a remote connection to the first client and the second client, respectively.
S13. The first client and the second client respond to the verification request for establishing a remote connection, respectively
S14. The remote server establishes a room for remote connection of the first client and the second client.
S15. The invention determines the legitimacy of the room status and user profiles of the first client and the second client, synchronizing the room information and completing the remote connection if legitimate.

According to an aspect of the technology, in S2, in the process of issuing control instructions to the electronic device via the first client and/or the second client, the electronic device is connected to the first client; if the control instructions are issued through the second client, the remote server receives the control instructions and transmits to the first client, and the first client transmits to the electronic device; If the control instructions are issued through the first client, the first client simultaneously transmits the control instructions to the remote server, and the remote server transmits to the second client for sharing.

According to an aspect of the technology, the electronic device is connected to the client via Bluetooth or WI-FI.

According to an aspect of the technology, the remote server is a WebSocket server.

According to a solution of the invention, the invention realizes the control of the electronic device connected to at least one of the clients through two remotely connected clients, enabling real-time interaction online even if the two clients have a large distance separated, guaranteeing the instantaneity of the interaction.

According to a solution of the invention, the first client and the second client interact through the room established on the remote server, to ensure the security and privacy of the interaction process, and effectively protect the privacy of the client.

According to a solution of the invention, controlling the electronic device by using either client can realize the two-way nature of the interaction between the clients, resulting in a rich and interesting interaction process.

According to a solution of the invention, the temporal sequence of control instructions can be arranged on the first client and the second client by adopting a timeline, enabling the playback and adjustment of the interaction process by the user, resulting in the optimal effect of the whole interaction process.

### 4. BRIEF DESCRIPTION OF ACCOMPANY DRAWINGS

FIG. 1 is a schematic diagram showing a step-by-step block diagram of an interactive method according to an embodiment provided by the invention.

FIG. 2 is a schematic diagram showing a flowchart of an interactive method according to an embodiment provided by the invention.

### 5. SPECIFIC EMBODIMENT OF THE INVENTION

To make the technical solutions provided by the unity model more comprehensible, the accompanying drawings required for use in the description of embodiments or prior art are briefly described below. Apparently, the described drawings are merely some embodiments of the application rather than all the embodiments of the application. It should be understood that the application is not limited to the drawings described herein. Based on the drawings in the disclosure, all other drawings obtained by those of ordinary skill in the art without making creative labor fall within the scope of protection of the disclosure.

In the specification of the disclosure, it is to be understood that terms such as ‘lengthwise’, ‘transverse’, ‘up’, ‘down’, ‘front’, ‘back’, ‘left’, ‘right’, ‘vertical’, ‘horizontal’, ‘top’, ‘bottom’, ‘inside’, ‘outside’ refer to the orientations and location relations which are the orientations and location relations illustrated in the drawings, and for describing the disclosure and for describing in simple, and which are not intended to indicate or imply that the device or the elements are disposed to locate at the specific directions or are structured and performed in the specific directions, which could not to be understood to the limitation of the disclosure.

The invention is described in detail hereinafter in connection with the accompanying drawings and specific embodiments, the embodiments of which cannot be described herein in detail, but the embodiments of the invention are not thereby limited to the following embodiments.

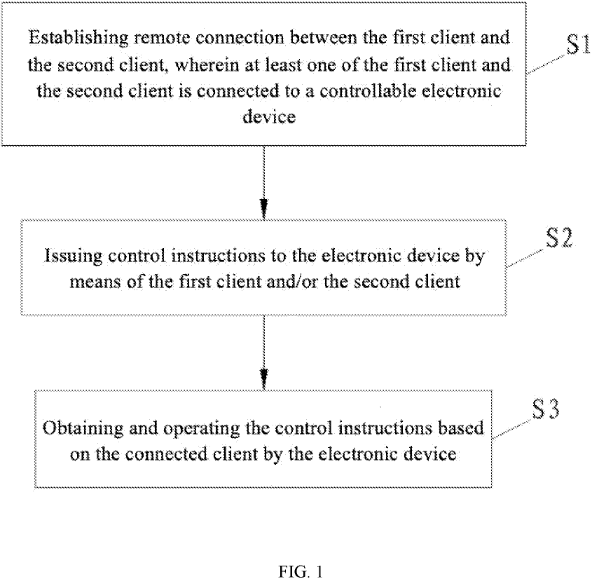

As shown in FIG. 1, according to an embodiment of the invention, a remote control based interaction method provided by the invention, wherein comprises:
S1. The first client establishes remote connection with a second client, wherein at least one of the first client and the second client is connected to a controllable electronic device.
S2. The invention issues control instructions to the electronic device by means of the first client and/or the second client.
S3. The electronic device obtains and operates the control instructions based on the connected client.

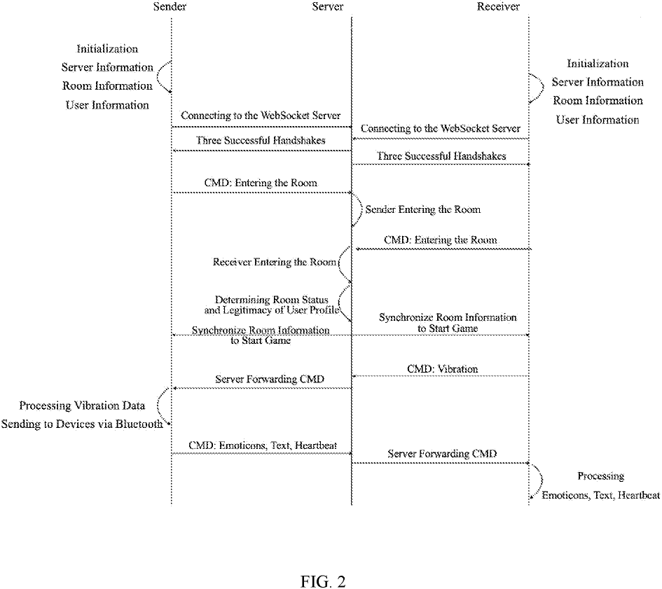

As shown in FIG. 2, according to an embodiment of the invention, in step S1, the first client and the second client adopt multimedia mobile devices including cell phones and smart watches with networking capabilities. In this embodiment, the first client and the second client are connected to the remote server, respectively. In this embodiment, the electronic device can be connected at one client, and also can be connected separately at both clients. In this embodiment, the remote server is a WebSocket server. In this embodiment, the electronic device is connected to the client via Bluetooth or WIFI.

As shown in FIG. 2, according to an embodiment of the invention, in S1, the process of establishing a remote connection between the first client and the second client comprises:
S11. The first client and the second client send a request to establish a remote connection to the remote server, respectively
S12. The remote server responds to the remote connection request and sends a verification request for establishing a remote connection to the first client and the second client, respectively. In this embodiment, the remote server sends handshake protocols to the first client and the second client, respectively.
S13. The first client and the second client respond to the verification request for establishing a remote connection, respectively. In this embodiment, both the first client and the second client receive the handshake protocol and perform handshake verification.
S14. The remote server establishes a room for remote connection of the first client and the second client. In this embodiment, after three successful handshakes between the first client and the second client, the first client and the second client enter the established room through the remote server. In this embodiment, the room can be established at the remote server by the request from the first client, and after the first client enters the room, the second client receives the room invitation to enter the room.
S15. The invention determines the legitimacy of the room status and user profiles of the first client and the second client, synchronizing the room information and completing the remote connection if legitimate.

According to an embodiment of the invention, in S1, in the process of establishing a remote connection between the first client and the second client, the first client and the second client simultaneously establish an instant messaging window for instant message interaction. In this embodiment, in the room created by the remote server, the first client and the second client carry out messages such as emoticons and texts through the instant messaging window.

As shown in FIG. 2, according to an embodiment of the invention, in S2, in the process of issuing control instructions to the electronic device via the first client and/or the second client, the electronic device is connected to the first client; if the control instructions are issued through the second client, the remote server receives the control instructions and transmits to the first client, and the first client transmits to the electronic device. For instance, if the second client sends a control instruction for vibration, it will be forwarded to the first client via the room on the remote server, and the first client receives the control instructions for vibration and transmits to the electronic device via Bluetooth or Wi-Fi. The electronic device receives the control instructions to perform vibration. The electronic device can also send an instant message to the second client via the instant messaging window while receiving the control instructions via the first client.

In this embodiment, the electronic device is connected to the first client, and if the control instructions are transmitted via the first client, the first client sends them directly to the electronic device via Bluetooth or Wi-Fi. At the same time, the first client simultaneously sends the control instructions to the remote server, and the remote server transmits to the second client for sharing.

According to an embodiment of the invention, in S2, in the process of issuing control instructions to the electronic device via the first client and/or the second client, a timeline is established simultaneously in the display interface of the first client and the second client, to record and display the control instructions according to the timeline.

According to an embodiment of the invention, the temporal sequence of the control instructions can be adjusted according to the timeline through the first client or the second client, to update the displays simultaneously at the first client and the second client.

According to an embodiment of the invention, the interaction method provided by the invention further comprises:

S4. The electronic device starting to operate and providing operational data and data collected through sensors on the electronic device as feedback to the connected client for sharing via remote connection.

According to an embodiment of the invention, in S4, after starting the operation of the electronic device, the client connected to the electronic device optionally activates the available sound capture device and/or video capture device to collect the surrounding environment information for sharing via remote connection. The above settings allow for a more realistic and interesting environment for the entire interactive process.

The above description is only an embodiment of specific solutions provided by the invention. For the equipment and structures not described in detail therein, it should be understood that common equipment and common methods available in the field are adopted to perform them.

The invention and the embodiments thereof are described hereinabove, and this description is not restrictive. What is shown in the drawings is only one of the preferred embodiments of the invention, and the actual structure is not limited thereto. Although embodiments of the invention have been shown and described, it will be understood by those of ordinary skill in the art that the technical solutions modification and equivalent substitutions for some of the technical features can be made without departing from the principles and spirit of the invention. In summary, any modification, equivalent replacement, improvement without departing from the inventive purpose of the invention in the art without creative efforts shall all fall within the protection scope of the invention.

1. A remote control based interaction method, wherein comprises:
S1. establishing remote connection between the with the first client and the second client, wherein at least one of the first client and the second client is connected to a controllable electronic device;
S2. issuing control instruction to the electronic device by means of the first client and/or the second client;
S3. obtaining and operating the control instructions based on the connected client by the electronic device.

2. A remote control based interaction method according to claim 1, wherein further comprises:
S4. Starting to operate and providing operational data and data collected through sensors on the electronic device as feedback to the connected client for sharing via remote connection.

3. A remote control based interaction method according to claim 1 or 2, wherein in S1, in the process of establishing a remote connection between the first client and the second client, the first client and the second client simultaneously establish an instant messaging window for instant message interaction.

4. A remote control based interaction method according to claim 3, wherein in S4, after starting the operation of the electronic device, the client connected to the electronic device optionally activates the available sound capture device and/or video capture device to collect the surrounding environment information for sharing via remote connection.

5. A remote control based interaction method according to claim 1 or 2, wherein in S2, in the process of issuing control instructions to the electronic device via the first client and/or the second client, a timeline is established simultaneously in the display interface of the first client and the second client, to record and display the control instructions according to the timeline.

6. A remote control based interaction method according to claim 5, wherein the temporal sequence of the control instructions can be adjusted according to the timeline through the first client or the second client, to update the displays simultaneously at the first client and the second client.

7. A remote control based interaction method according to claim 3, wherein in S1, in the process of establishing a remote connection between the first client and the second client, comprising:
S11. the first client and the second client sending a request to establish a remote connection to the remote server, respectively;
S12. the remote server responding to the remote connection request and sending a verification request for establishing a remote connection to the first client and the second client, respectively;
S13. the first client and the second client responding to the verification request for establishing a remote connection, respectively;
S14. the remote server establishing a room for remote connection of the first client and the second client;
S15. the invention determining the legitimacy of the room status and user profiles of the first client and the second client, and synchronizing the room information and completing the remote connection if legitimate.

8. A remote control based interaction method according to claim 7, wherein in S2, in the process of issuing control instructions to the electronic device via the first client and/or the second client, the electronic device is connected to the first client; if the control instructions are issued through the second client, the remote server receives the control instructions and transmits to the first client, and the first client transmits to the electronic device; If the control instructions are issued through the first client, the first client simultaneously transmits the control instructions to the remote server, and the remote server transmits to the second client for sharing.

9. A remote control based interaction method according to claim 1 or 8, wherein the electronic device is connected to the client via Bluetooth or WIFI.

10. A remote control based interaction method according to claim 1 or 8, wherein the remote server is a WebSocket server.
